(19) United States
(12) Patent Application Publication
(10) Pub. No.: US 2025/0062072 A1
(43) Pub. Date: Feb. 20, 2025

(54) CERAMIC CAPACITOR AND METHOD FOR MANUFACTURING SAME

(71) Applicant: AMOTECH CO., LTD., Incheon (KR)

(72) Inventors: Byungguk LIM, Incheon (KR); Yunsuk CHOI, Incheon (KR); Jaeyong SONG, Incheon (KR)

(73) Assignee: AMOTECH CO., LTD., Incheon (KR)

(21) Appl. No.: 18/721,364

(22) PCT Filed: Dec. 6, 2022
(86) PCT No.: PCT/KR2022/019713

§ 371 Date: Jun. 18, 2024

(30) Foreign Application Priority Data
Dec. 20, 2021 (KR) 10-2021-0182326
Dec. 20, 2021 (KR) 10-2021-0182329

(51) Int. Cl. H01G 4/012; H01G 4/248; H01G 4/30

(52) U.S. Cl. CPC H01G 4/012; H01G 4/248; H01G 4/30

(57) ABSTRACT

A ceramic capacitor and a method for manufacturing same, and comprises: a ceramic body including dielectric layers and having front and rear surfaces facing each other, upper and lower surfaces facing each other, and both end surfaces facing each other; a first edge cutting surface formed such that one end surface among both end surfaces of the ceramic body and the front and rear surfaces of the ceramic body meet each other; a second edge cutting surface formed such that the other end surface opposite to the one end surface among both end surfaces of the ceramic body and the front and rear surfaces of the ceramic body meet each other; at least one first internal electrode disposed and at least one second internal electrode.

### TECHNICAL FIELD

The present disclosure relates to a ceramic capacitor, and more particularly, to a ceramic capacitor capable of implementing a maximum contact area upon contact of an external electrode and an internal electrode, and a method of manufacturing the same.

### BACKGROUND ART

A capacitor is used to protect a corresponding part by storing electricity when there is a part for which a voltage needs to be constantly maintained and uniformly and stably supplying electricity required by the part, used to remove noise within an electronic device, or used to transmit only an AC signal from a signal in which a DC and an AC are mixed.

In general, a ceramic capacitor consists of a dielectric, an internal electrode, and an external electrode. The ceramic capacitor has internal electrodes of many layers accumulated within a limited space because electric charges are accumulated between the internal electrodes that face each other, thereby implementing miniaturization and a higher capacity. In such a capacitor, connection strength between an external electrode and an internal electrode is increased and contact resistance is reduced only when a contact area is wide upon contact of the external electrode and the internal electrode. However, the capacitor has a problem in that it is difficult to secure the contact area of the external electrode and the internal electrode to the maximum because only one side of the internal electrode is exposed and it is difficult for the internal electrode to be uniformly exposed in a straight line on the exposed surface.

The contents described in the Background Art are to help the understanding of the background of the disclosure, and may include contents that are not a disclosed conventional technology.

### DISCLOSURE

### Technical Problem

An object of the present disclosure is to provide a stack type ceramic capacitor capable of increasing connection strength between an external electrode and an internal electrode and reducing contact resistance and capable of mass production by implementing the ceramic capacitor so that a maximum contact area is secured upon contact of the external electrode and the internal electrode, and a method of manufacturing the same.

### Technical Solution

A ceramic capacitor according to an embodiment of the present disclosure for solving the above problem includes a ceramic body including a plurality of dielectric layers and including front and rear surfaces that face each other, upper and lower surfaces that face each other, and both end surfaces that face each other, a first corner cutting plane formed to meet one end surface, among the both end surfaces of the ceramic body, and the front and rear surfaces of the ceramic body, a second corner cutting plane formed to meet the other end surface that is opposite to the one end surface, among the both end surfaces of the ceramic body, and the front and rear surfaces of the ceramic body, at least one first internal electrode disposed within the ceramic body and exposed to be connected to the one end surface of the ceramic body and the first corner cutting plane, and at least one second internal electrode disposed within the ceramic body, exposed to be connected to the other end surface of the ceramic body and the second corner cutting plane, and including a part that overlaps the first internal electrode.

The first corner cutting plane may be formed to have a curved surface.

The first internal electrode may be spaced apart from the front and rear surfaces of the ceramic body at a certain distance and not exposed to the outside.

The ceramic capacitor may further include first and second external electrodes disposed in the both end surfaces of the ceramic body, respectively, and connected to the first internal electrode and the second internal electrode, respectively. The first external electrode may cover the one end surface of the ceramic body and the first corner cutting plane.

The first internal electrode may have one side exposed to the one end surface of the ceramic body and the other side disposed within the ceramic body. The other side of the first internal electrode may be spaced apart from the second corner cutting plane at a certain distance.

The first internal electrode and the second internal electrode may be exposed to be connected to the front and rear surfaces of the ceramic body.

The ceramic capacitor may further include a side cover part bonded to the front and rear surfaces of the ceramic body and configured to cover the first internal electrode and the second internal electrode exposed to the front and rear surfaces of the ceramic body.

The side cover part may be made of dielectric.

The first external electrode may cover up to a part of the side cover part.

The first internal electrode may be disposed in the dielectric layer. The dielectric layer may expose both sides of the first internal electrode to the outside.

A method of manufacturing a ceramic capacitor includes a step of manufacturing a ceramic sheet stack body by stacking a plurality of dielectric layers including a dielectric layer on which a first internal electrode has been printed and a dielectric layer on which a second internal electrode has been printed, a step of forming a through hole at each set location of the ceramic sheet stack body, and a step of manufacturing a plurality of ceramic bodies in each of which first corner cutting planes are formed on both sides of one end surface thereof and second corner cutting planes are formed on both sides of the other end surface thereof by cutting the ceramic sheet stack body in a plurality of cell units so that the through hole is quartered on the basis of a center of the through hole.

In the step of manufacturing the ceramic sheet stack body by stacking the plurality of dielectric layers including the dielectric layer on which the first internal electrode has been printed and the dielectric layer on which the second internal electrode has been printed, the first internal electrode may be printed on an upper surface of the dielectric layer in a plural number so that the first internal electrode has one side come into contact with one end surface of the dielectric layer or come into contact with a cutting line part that is to become the one end surface of the dielectric layer, has the other side spaced apart from a cutting line part that is to become the other end surface of the dielectric layer or the other end surface of the dielectric layer at a certain distance, and has both sides spaced apart from front and rear surfaces of the dielectric layer or a cutting line part that is to become the front and rear surfaces of the dielectric layer at a certain distance.

In the step of manufacturing the ceramic sheet stack body by stacking the plurality of dielectric layers including the dielectric layer on which the first internal electrode has been printed and the dielectric layer on which the second internal electrode has been printed, the second internal electrode may be printed on an upper surface of the dielectric layer in a plural number so that the second internal electrode has one side come into contact with the other end surface of the dielectric layer or come into contact with a cutting line part that is to become the other end surface of the dielectric layer, has the other side spaced apart from a cutting line part that is to become the one end surface of the dielectric layer or the one end surface of the dielectric layer at a certain distance, and has both sides spaced apart from front and rear surfaces of the dielectric layer or a cutting line part that is to become the front and rear surfaces of the dielectric at a certain distance.

The step of forming the through hole at each set location of the ceramic sheet stack body and the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole may be simultaneously performed by using a punching machine having a cylinder shape and a punching device having a punch blade.

A step of plasticizing the ceramic body may be performed after the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole. A step of forming first and second external electrodes that connect the first and second internal electrodes to the both end surfaces of the ceramic body, respectively, may be performed after the step of plasticizing the ceramic body. The first external electrode may be formed to cover the one end surface of the ceramic body and the first corner cutting plane.

The method may further include a step of bonding a side cover part to front and rear surfaces of the ceramic body, after the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole.

In the step of manufacturing the ceramic sheet stack body by stacking the plurality of dielectric layers including the dielectric layer on which the first internal electrode has been printed and the dielectric layer on which the second internal electrode has been printed. The first internal electrode may be printed on an upper surface of the dielectric layer in a plural number so that the first internal electrode has one side come into contact with one end surface of the dielectric layer or come into contact with a cutting line part that is to become the one end surface of the dielectric layer, has the other side spaced apart from a cutting line part that is to become the other end surface of the dielectric layer or the other end surface of the dielectric layer at a certain distance, and has both sides exposed to front and rear surfaces of the dielectric layer.

In the step of manufacturing the ceramic sheet stack body by stacking the plurality of dielectric layers including the dielectric layer on which the first internal electrode has been printed and the dielectric layer on which the second internal electrode has been printed, the second internal electrode may be printed on an upper surface of the dielectric layer in a plural number so that the second internal electrode has one side come into contact with the other end surface of the dielectric layer or come into contact with a cutting line part that is to become the other end surface of the dielectric layer, has the other side spaced apart from a cutting line part that is to become the one end surface of the dielectric layer or the one end surface of the dielectric layer at a certain distance, and has both sides exposed to front and rear surfaces of the dielectric layer.

In the step of bonding the side cover part to the front and rear surfaces of the ceramic body, the side cover part made of dielectric and configured to have a flat panel shape may be bonded to the front and rear surfaces of the ceramic body except the corner cutting plane, or the side cover part may be formed by printing a dielectric material on the front and rear surfaces of the ceramic body except the corner cutting plane.

The step of plasticizing the ceramic body may be performed after the step of bonding the side cover part to the front and rear surfaces of the ceramic body. A step of forming first and second external electrodes connected to the first and second internal electrodes, respectively, in the both end surfaces of the ceramic body may be performed after the step of plasticizing the ceramic body. The first external electrode may be formed to cover the one end surface of the ceramic body, the first corner cutting plane, and up to a part of the side cover part.

### Advantageous Effects

In the present disclosure, the plurality of ceramic bodies in each of which the corner cutting plane has been formed is manufactured by cutting the ceramic sheet stack body in a plurality of cell units. The contact area of an external electrode and an internal area is increased by an internal electrode that is exposed through the corner cutting plane. Accordingly, effects in that contact resistance of the external electrode and the internal electrode is reduced and equivalent series resistance (ESR) is reduced may be expected.

Furthermore, in the present disclosure, the ceramic body has a clean cutting surface because the ceramic body is manufactured by cutting the ceramic sheet stack body in a cell unit. An internal electrode is uniformly exposed, and the contact area of an external electrode and an internal area is increased. Accordingly, an effect in that equivalent series resistance (ESR) is reduced by increasing the contact area of the external electrode and the internal electrode to the maximum may be expected.

Furthermore, in the present disclosure, the printing and manufacturing of an internal electrode are easy because the ceramic body is manufactured by cutting the ceramic sheet stack body manufactured to have a large area in a cell unit, but has a structure in which both sides of an internal electrode are exposed to the front and rear surfaces of the ceramic body. Insulation can be secured by bonding the side cover part to both sides of the internal electrode that are exposed to the front and rear surfaces of the ceramic body. The internal electrode is also uniformly exposed and the contact area of the external electrode and the internal area is increased because the ceramic body has a clean cutting surface. Accordingly, there is an effect in that the contact area of the external electrode and the internal electrode can be increased to the maximum.

### DESCRIPTION OF DRAWINGS

FIG. 1 is a partial perspective view illustrating a ceramic body of a ceramic capacitor according to a first embodiment of the present disclosure.

FIG. 2 is a perspective view illustrating the ceramic capacitor according to the first embodiment of the present disclosure.

FIG. 3 is a longitudinal cross-sectional view illustrating the ceramic capacitor according to the first embodiment of the present disclosure.

FIG. 4 is an exploded perspective view illustrating the ceramic capacitor according to the first embodiment of the present disclosure.

FIG. 5 is a flowchart illustrating a method of manufacturing the ceramic capacitor according to the first embodiment of the present disclosure.

FIG. 6 is a construction diagram illustrating the method of manufacturing the ceramic capacitor according to the first embodiment of the present disclosure.

FIG. 7 is a partial perspective view illustrating a form before a side cover part is bonded to a ceramic body of a ceramic capacitor according to a second embodiment of the present disclosure.

FIG. 8 is a perspective view illustrating the state in which the side cover part has been bonded to the ceramic body of the ceramic capacitor according to the second embodiment of the present disclosure.

FIG. 9 is a perspective view illustrating the ceramic capacitor according to the second embodiment of the present disclosure.

FIG. 10 is a longitudinal cross-sectional view illustrating the ceramic capacitor according to the second embodiment of the present disclosure.

FIG. 11 is an exploded perspective view illustrating the ceramic capacitor according to the second embodiment of the present disclosure.

FIG. 12 is a flowchart illustrating a method of manufacturing the ceramic capacitor according to the second embodiment of the present disclosure.

FIG. 13 is a construction diagram illustrating the method of manufacturing the ceramic capacitor according to the second embodiment of the present disclosure.

### BEST MODE

Hereinafter, preferred embodiments of the present disclosure are described in detail with reference to the accompanying drawings.

### First Embodiment

A ceramic capacitor according to a first embodiment of the present disclosure is characterized in that an internal electrode is additionally exposed by hole-punching corner parts of a ceramic body so that a maximum contact area can be implemented upon contact of an external electrode and the internal electrode and side shaping for insulation is not required because the side of the internal electrode is not exposed to the outside. The ceramic capacitor is a multi-layer ceramic capacitor (MLCC), for example.

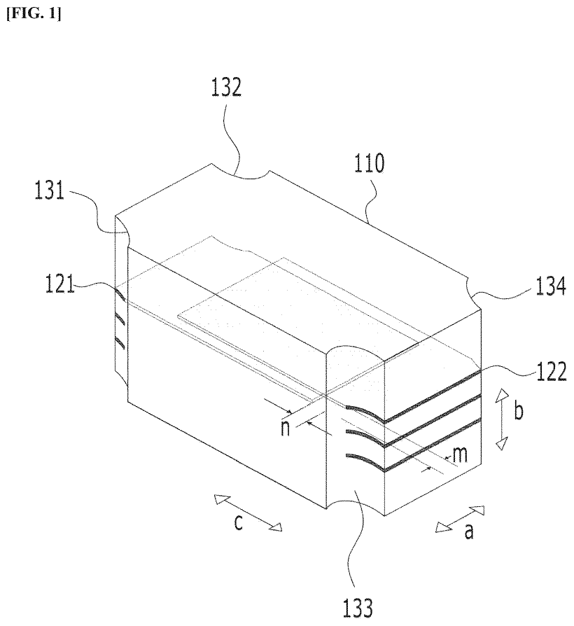

FIG. 1 is a partial perspective view illustrating a ceramic body of the ceramic capacitor according to the first embodiment of the present disclosure. In the drawing, a relative thickness or length, or a relative size may be exaggerated for convenience of description and clarity.

As illustrated in FIG. 1, a ceramic capacitor 100 according to the first embodiment of the present disclosure includes a ceramic body 110, first and second internal electrodes 121 and 122, and corner cutting planes 131, 132, 133, and 134.

The ceramic body 110 includes a plurality of dielectric layers. The ceramic body 110 is formed by horizontally stacking a plurality of dielectric layers 111 and then plasticizing the plurality of dielectric layers. The plurality of dielectric layers 111 is in the state the plurality of dielectric layers has been sintered. A boundary between adjacent dielectric layers 111 may be integrated to the extent that it is difficult to check the boundary.

A material of the dielectric layer 111 may be barium titanate (BaTiO₃)-based ceramics having a high dielectric constant. In addition, (Ca, Zr)(Sr, Ti)O₃-based ceramics may be used as a material that forms the dielectric layer 111, or the material may additionally include the (Ca, Zr)(Sr, Ti)O₃-based ceramics. However, it is preferred that the dielectric material BaTiO₃ having a high dielectric constant is used because capacitance is proportional to the dielectric constant of the dielectric.

The ceramic body 110 is formed in an approximately rectangular parallelepiped shape, and includes front and rear surfaces that face each other, upper and lower surfaces that face each other, and both end surfaces that face each other. The lower surface of the ceramic body 110 is a mounting surface that is mounted on a board. A surface that faces the lower surface is the upper surface. Two surfaces that are orthogonal to the upper and lower surfaces and that have a long length are the front and rear surfaces. Two surfaces that are orthogonal to the upper and lower surfaces and that have a short length are both end surfaces. That is, in the ceramic body 110, two surfaces that face each other in a direction a are the front and rear surfaces, two surfaces that face each other in a direction b are the upper and lower surfaces, and two surfaces that face each other in a direction c are both end surfaces.

The first internal electrode 121 and the second internal electrode 122 are disposed to have at least one layer within the ceramic body 110. For example, the first internal electrode 121 and the second internal electrode 122 may be disposed to have three layers or more within the ceramic body 110, and may be disposed to have several tens or several hundreds of layers in order to increase capacitance.

The first internal electrode 121 has one side exposed to one end surface, among both end surfaces of the ceramic body 110, and has the other side that is opposite to the one side disposed within the ceramic body 110. The second internal electrode 122 has one side exposed to the other end surface that is opposite to the one end surface, among both end surfaces of the ceramic body 110, has the other side that is opposite to the one side disposed within the ceramic body 110, and includes a part that overlaps the first internal electrode 121. Capacitance is formed at the part at which the first internal electrode 121 and the second internal electrode 122 overlap.

The first internal electrode 121 and the second internal electrode 122 may each be formed in various shapes. In an embodiment, the first internal electrode 121 and the second internal electrode 122 may each have a square shape in which the length of the internal electrode is greater than the width of the internal electrode, for example. In the first internal electrode 121 and the second internal electrode 122, a part that is exposed to both end surfaces of the ceramic body 110 is denoted as one side, a surface that is opposite to the one side is denoted as the other side, surfaces that face the front and rear surfaces of the ceramic body 110 are denoted as sides.

The corner cutting planes 131, 132, 133, and 134 are formed by cutting four corners of the ceramic body 110 in up and down directions. The first internal electrode 121 or the second internal electrode 122 is exposed to the corner cutting plane 131, 132, 133, 134. The first internal electrode 121 is exposed to the two corner cutting planes 131 and 132 that neighbor one end surface of the ceramic body 110. The second internal electrode 122 is exposed to the two corner cutting planes 133 and 134 that neighbor the other end surface that is opposite to the one end surface of the ceramic body 110.

In an embodiment, the corner cutting planes 131, 132, 133, and 134 are divided into first corner cutting planes 131 and 132 and second corner cutting planes 133 and 134. The first corner cutting planes 131 and 132 are formed so that one end surface, among both end surfaces of the ceramic body 110, and the front and rear surfaces of the ceramic body 110 meet each other. The second corner cutting planes 133 and 134 are formed so that the other end surface that is opposite to the one end surface, among both end surfaces of the ceramic body 110, and the front and rear surfaces of the ceramic body meet each other. Furthermore, the first internal electrode 121 consists of at least one first internal electrode that is disposed within the ceramic body 110 and that is exposed to be connected to one end surface of the ceramic body 110, the first corner cutting planes 131 and 132, and the front and rear surfaces of the ceramic body 110. The second internal electrode 122 consists of at least one second internal electrode that is disposed within the ceramic body 110, that is exposed to be connected to the other end surface of the ceramic body 110, the second corner cutting planes 133 and 134, and the front and rear surfaces of the ceramic body 110, and that includes a part that overlaps the first internal electrode 121.

The corner cutting planes 131, 132, 133, and 134 may each be formed to have a curved surface. For example, the corner cutting planes 131, 132, 133, and 134 may each have a shape in which the corner cutting plane is depressed from the outside thereof to the inside. The corner cutting planes 131, 132, 133, and 134 additionally expose the first internal electrode 121 and the second internal electrode 122. The first internal electrode 121 and the second internal electrode 122 that are exposed through the corner cutting planes 131, 132, 133, and 134 widen a contact area with an external electrode by increasing the exposure area and exposure length of the first internal electrode 121 and the second internal electrode 122.

In addition, the corner cutting planes 131, 132, 133, and 134 may each have a straight-line shape. However, it is preferred that the corner cutting planes 131, 132, 133, and 134 each have a curved surface shape in order to widen the contact area of the external electrode 141, 142 and the internal electrode 121, 122 and increase contact reliability.

The first internal electrode 121 and the second internal electrode 122 are spaced apart from the front and rear surfaces of the ceramic body 110 at a certain distance m and are thus not exposed to the outside. That is, the first internal electrode 121 and the second internal electrode 122 do not require side shaping for insulating because the sides of the first internal electrode and the second internal electrode are not exposed to the outside.

In an embodiment, the first internal electrode 121 is exposed to one end surface, among both end surfaces of the ceramic body 110, and is also exposed through the first corner cutting planes 131 and 132 that neighbor the one end surface of the ceramic body 110, so that the exposed part forms a “⊏” shape. The second internal electrode 122 is exposed to the other end surface, among both end surfaces of the ceramic body 110, and is also exposed through the second corner cutting planes 133 and 134 that neighbor the other end surface of the ceramic body 110, so that the exposed part forms a “⊏” shape.

The exposure structure of each of the first internal electrode 121 and the second internal electrode 122 each having the “⊏” shape increases connection strength of an external electrode and the internal electrode and reduces contact resistance by securing a maximum contact area upon contact of the external electrode and the internal electrode. A reduction of the contact resistance increases the safety of the entire circuit and improves the lifespan thereof by reducing equivalent series resistance (ESR).

The other side of the first internal electrode 121 and the other side of the second internal electrode 122 are spaced apart from corner cutting planes at locations at which they face each other, respectively, at a certain distance n. If the other side of the first internal electrode 121 is extended up to the second corner cutting planes 133 and 134 that face the other side of the first internal electrode and disposed or the other side of the second internal electrode 122 is extended up to the first corner cutting planes 131 and 132 that face the other side of the second internal electrode and disposed, a short occurs because both the first internal electrode 121 and the second internal electrode 122 are exposed to the corner cutting planes 131, 132, 133, and 134.

It is preferred that the width of each of the first and second corner cutting planes 131, 132, 133, and 134 is smaller than the width of both end surfaces of the ceramic body.

The first and second internal electrodes 121 and 122 may be made of one of Cu, Ni, and Pd-Ag or an alloy of them. In order to suppress the oxidation of the internal electrode during a plasticizing process that is performed at a high temperature, Pd, that is, expensive precious metal, may be used as the internal electrode. For a cost reduction according to requirements for miniaturization and higher capacity of an MLCC, Pd-Ag, Ni, Cu, etc. may be used as the internal electrode.

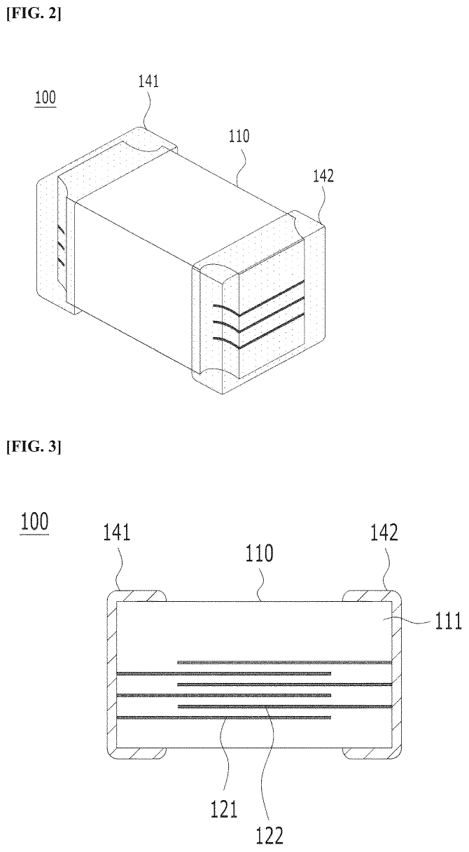

FIG. 2 is a perspective view illustrating the ceramic capacitor according to the first embodiment of the present disclosure.

As illustrated in FIG. 2, the ceramic capacitor 100 includes first and second external electrodes 141 and 142. The first and second external electrodes 141 and 142 are disposed in both end surfaces of the ceramic body 110, respectively, and are connected to the first internal electrode 121 and the second internal electrode 122, respectively.

Referring to FIGS. 1 and 2, the first external electrode 141 is formed to cover one end surface of the ceramic body 110 and the first corner cutting planes 131 and 132. The second external electrode 142 is formed to cover the other end surface of the ceramic body 110 and the second corner cutting planes 133 and 134.

In an embodiment, the first and second external electrodes 141 and 142 is formed to cover both end surfaces of the ceramic body 110, the corner cutting planes 131, 132, 133, and 134, and a part of the ceramic body 110. The first and second external electrodes 141 and 142 can maximize their contact areas because the first and second external electrodes also come into contact with the first internal electrode 121 and the second internal electrode 122 that are exposed through the corner cutting planes 131, 132, 133, and 134 by being formed to cover the corner cutting planes 131, 132, 133, and 134.

The first and second external electrodes 141 and 142 may be formed by plating an external electrode material so that the first and second external electrodes cover both end surfaces of the ceramic body 110 and the corner cutting planes 131, 132, 133, and 134. The first and second external electrodes 141 and 142 may be formed in a form in which the first and second external electrodes fully cover the corner cutting planes 131, 132, 133, and 134.

Ag or Cu having high electrical conductivity may be used as an external electrode material. Plating layers may be further formed in each of the first and second external electrodes 141 and 142 by plating Ni and Sn. If the Ni and Sn plating layers are further formed in each of the first and second external electrodes 141 and 142, an adhesive force for a board can be increased and moisture resistance can be improved. For example, the first and second external electrodes 141 and 142 may each be formed to have a three-layer structure including a Cu layer, an Ni layer formed to cover the Cu layer, and an Sn layer formed to cover the Ni layer. Alternatively, the first and second external electrodes 141 and 142 may each be formed to have a four-layer structure having a shock buffer function, further including an Ag epoxy layer between the Cu layer and the Ni layer.

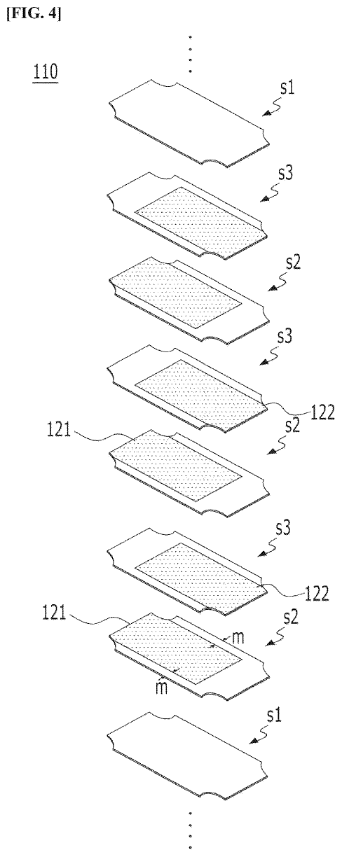

FIG. 3 is a longitudinal cross-sectional view illustrating the ceramic capacitor according to the first embodiment of the present disclosure.

As illustrated in FIG. 3, the first and second internal electrodes 121 and 122 are formed within the ceramic body 110. The first internal electrode 121 is exposed to one end surface, among both end surfaces of the ceramic body 110. The second internal electrode 122 is exposed to the other end surface, among both end surfaces of the ceramic body 110, and includes a part that overlaps the first internal electrode 121.

The first and second internal electrodes 121 and 122 are electrically connected to the first and second external electrodes 141 and 142 that are disposed to surround both end surfaces of the ceramic body 110, respectively. In the ceramic capacitor 100, when a voltage is applied to the first and second external electrodes 141 and 142, electric charges are accumulated between the first internal electrode 121 and the second internal electrode 122. In this case, capacitance is proportional to the area of a region in which the first internal electrode 121 and the second internal electrode 122 overlap. The first and second internal electrodes 121 and 122 may each be formed in a plural number. The first and second internal electrodes 121 and 122 may each be formed by printing the internal electrode material on the dielectric layer.

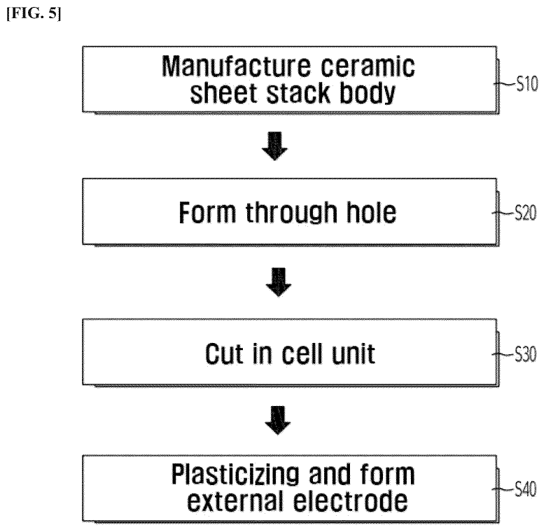

FIG. 4 is an exploded perspective view illustrating the ceramic capacitor according to the first embodiment of the present disclosure.

As illustrated in FIG. 4, the ceramic capacitor 100 may have a form in which a second dielectric layer s2 in which the first internal electrode 121 is disposed and a third dielectric layer s3 in which the second internal electrode 122 is disposed are alternately stacked on a first dielectric layer s1 that is made of only dielectric and that has at least one layer, at least once, and a first dielectric layer sl made of only dielectric is stacked on them at least once.

The first internal electrode 121 and the second internal electrode 122 each have a certain area so that the first internal electrode and the second internal electrode overlap, and each include a side margin part m, so that the sides of the first internal electrode 121 and the second internal electrode 122 are not exposed to the outside. The side margin part m is a dielectric part that makes parts of the second dielectric layer s2, which will become the front and rear surfaces of the ceramic body 110, and both sides of the first internal electrode 121 disposed in the second dielectric layer s2 spaced apart from each other at a certain distance. Furthermore, the side margin part m is a dielectric part that makes parts of the third dielectric layer s3, which will become the front and rear surfaces of the ceramic body 110, and both sides of the second internal electrode 122 disposed in the third dielectric layer s3 spaced apart from each other at a certain distance. The side margin part m makes each of the first internal electrode 121 and the second internal electrode 122 spaced apart from the front and rear surfaces of the ceramic body 110 at the certain distance m so that both sides of each of the first internal electrode 121 and the second internal electrode 122 are not exposed to the outside. That is, the side margin part m insulates the first internal electrode 121 and the second internal electrode 122, and the external electrodes on the front and rear surfaces of the ceramic body 110.

Furthermore, the first internal electrode 121 and the second internal electrode 122 may each be exposed through its end and connected to the external electrode. That is, the first internal electrode 121 may be disposed to be exposed to one end surface of the second dielectric layer s2 and three faces of the corner cutting planes 131 and 132 on both sides thereof, which neighbor the one end surface. Furthermore, the second internal electrode 122 may be disposed to be exposed to the other end surface of the third dielectric layer s3 and three faces of the corner cutting planes 133 and 134 on both sides thereof, which neighbor the other end surface.

The first internal electrode 121 and the second internal electrode 122 may be formed by printing the internal electrode material on upper surfaces of the second dielectric layer s2 and the third dielectric layer s3.

The first and second external electrodes 141 and 142 may each be formed by printing or applying an external electrode material to both end surfaces of the ceramic body 110 that is manufactured by stacking dielectric layers and compressing, cutting, and plasticizing the dielectric layers.

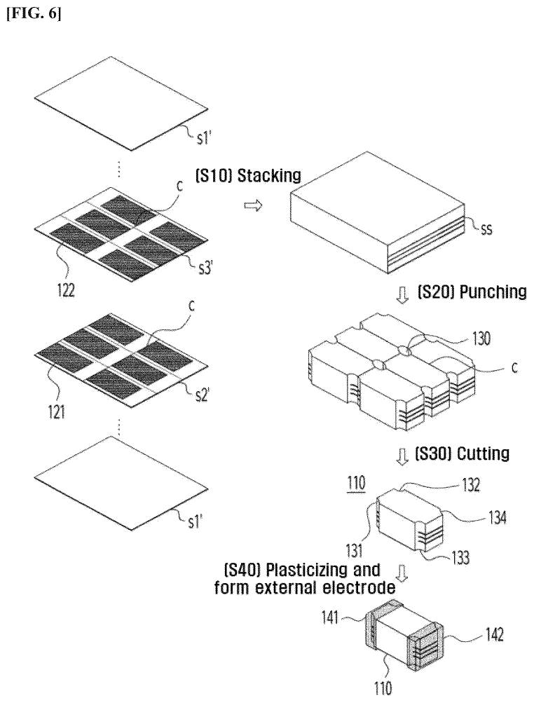

FIG. 5 is a flowchart illustrating a method of manufacturing the ceramic capacitor according to the first embodiment of the present disclosure. FIG. 6 is a construction diagram illustrating the method of manufacturing the ceramic capacitor according to the first embodiment of the present disclosure.

As illustrated in FIGS. 5 and 6, the method of manufacturing the ceramic capacitor includes a step S10 of manufacturing a ceramic sheet stack body ss by stacking the plurality of dielectric layers 111 including the second dielectric layer s2 on which the first internal electrode 121 has been printed and the third dielectric layer s3 on which the second internal electrode 122 has been printed, a step S20 of forming a through hole 130 at each set location of the ceramic sheet stack body ss, and a step S30 of manufacturing the plurality of ceramic bodies 110 in each of which the first corner cutting planes 131 and 132 are formed on both sides of one end surface thereof and the second corner cutting planes 133 and 134 are formed on both sides of the other end surface thereof by cutting the ceramic sheet stack body ss in a plurality of cell units so that the through hole 130 is quartered on the basis of the center of the through hole 130. The method further includes a step S40 of forming the first external electrode 141 that covers one end surface of the ceramic body 110 and the first corner cutting planes 131 and 132 and the second external electrode 142 that covers the other end surface of the ceramic body 110 and the second corner cutting planes 133 and 134, after the step S30 of manufacturing the ceramic body 110.

As illustrated in FIG. 6, in the step S10 of manufacturing the ceramic sheet stack body, the first internal electrode 121 is printed and disposed in a second dielectric layer s2′ in a plural number. The second internal electrode 122 is printed and disposed in a third dielectric layer s3′ in a plural number so that the second internal electrode includes a part that overlaps the first internal electrode 121.

A first dielectric layer s1′ is a ceramic sheet that is manufactured by using only a dielectric material. The second dielectric layer s2′ is formed by printing the plurality of first internal electrodes 121 on an upper surface of the ceramic sheet manufactured by using a dielectric material. The third dielectric layer s3′ is formed by printing the plurality of second internal electrodes 122 on the upper surface of the ceramic sheet manufactured by using a dielectric material.

The first internal electrode 121 is printed on an upper surface of the second dielectric layer s2′ in a plural number so that one side of the first internal electrode comes into contact with one end surface of the second dielectric layer s2′ or comes into contact with a cutting line (c) part that will become the one end surface, the other side of the first internal electrode is spaced apart from a cutting line (c) part that will become the other end surface of the second dielectric layer s2′ or the other end surface of the second dielectric layer s2′ at a certain distance, and both sides of the first internal electrode are spaced apart from front and rear surfaces of the second dielectric layer s2′ or a cutting line (c) part that will become the front and rear surfaces of the second dielectric layer s2′ at a certain distance.

The material of the dielectric layer 111 may be barium titanate (BaTiO₃)-based ceramics having a high dielectric constant.

A material of the first and second internal electrodes 121 and 122 may be formed of one of Cu, Ni, and Pd-Ag or an alloy of them.

The second internal electrode 122 is printed on an upper surface of the third dielectric layer s3′ in a plural number so that one side of the second internal electrode comes into contact with the other end surface of the third dielectric layer s3′ or comes into contact with a cutting line (c) part that will become the other end surface, the other side of the second internal electrode is spaced apart from a cutting line (c) part that will become one end surface of the third dielectric layer s3′ or the one end surface of the third dielectric layer s3′ at a certain distance, and both sides of the second internal electrode are spaced apart from front and rear surfaces of the third dielectric layer s3′ or a cutting line (c) part that will become the front and rear surfaces at certain distance.

In the step S20 of forming the through hole at each set location of the ceramic sheet stack body, the through hole 130 may be formed by using a punching machine having a cylinder shape or a laser. In an embodiment, for example, the plurality of through holes 130 is formed in the ceramic sheet stack body ss at certain intervals by using the punching machine having a cylinder shape.

The step S20 of forming the through hole at each set location of the ceramic sheet stack body and the step S30 of manufacturing the plurality of ceramic sheet stack body cell units in each of which the corner cutting planes 131, 132, 133, and 134 have been formed by cutting the ceramic sheet stack body ss so that the through hole is quartered on the basis of the center of the through hole may be simultaneously performed by using the punching machine having a cylinder shape and a punching device having a punch blade. If the forming of the through hole and the cutting of the ceramic sheet stack body ss are simultaneously performed by using the punching device, it is advantageous for mass production because a manufacturing time is reduced.

If the plurality of ceramic bodies 110 in each of which the corner cutting planes 131, 132, 133, and 134 have been formed by cutting the ceramic sheet stack body so that the through hole 130 is quartered on the basis of the center of the through hole 130 is manufactured, it is easy to implement a maximum contact area upon a contact with the external electrode 141, 142 because the plurality of ceramic bodies has the same clean cutting surface. If the contact area of the external electrode 141, 142 and the internal electrode 121, 122 is implemented to the maximum, ESR can be reduced.

After the step S30 of manufacturing the plurality of ceramic bodies 110 in each of which the corner cutting planes 131, 132, 133, and 134 have been formed by cutting the ceramic sheet stack body so that the through hole 130 is quartered on the basis of the center of the through hole 130, the step S40 of forming the first and second external electrodes 141 and 142 to cover both end surfaces of the ceramic body 110 and the first and second corner cutting planes 131, 132, 133, and 134 is performed.

Ag or Cu having high electrical conductivity may be used as the external electrode material.

After the step S10 of manufacturing the ceramic sheet stack body, a step of plasticizing the ceramic sheet stack body ss may be performed. Alternatively, after the step S30 of manufacturing the plurality of ceramic bodies 110 in each of which the corner cutting planes 131, 132, 133, and 134 have been formed by cutting the ceramic sheet stack body so that the through hole 130 is quartered on the basis of the center of the through hole 130, a step of plasticizing the ceramic body 110 may be performed. An embodiment exemplifies that the ceramic body 110 is plasticize and the first and second external electrodes 141 and 142 are formed to cover both end surfaces of the ceramic body 110 that have been plasticized and the corner cutting planes 131, 132, 133, and 134, after the step S30 of manufacturing the ceramic body.

The aforementioned embodiment has advantages in that it is easy to implement a maximum contact area upon contact of the external electrode and the internal electrode due to the clean cutting surface, the contact area of the external electrode and the internal electrode can be increased because the internal electrode is additionally exposed through the corner cutting plane and comes into contact with the external electrode, and the ceramic capacitor can be mass-produced through a simple process because insulation can be secured through the side margin part.

That is, in the embodiment of the present disclosure manufactured by the aforementioned method, the contact area of the external electrode and the internal area is increased by the internal electrode that is exposed through the corner cutting plane and because the plurality of ceramic bodies in each of which the corner cutting plane has been formed is manufactured by cutting the ceramic sheet stack body in a plurality of cell units. Accordingly, contact resistance of the external electrode and the internal electrode is reduced, and equivalent series resistance (ESR) is reduced.

Furthermore, in an embodiment of the present disclosure, the ceramic body has a clean cutting surface because the ceramic body is manufactured by cutting the ceramic sheet stack body in a cell unit. Accordingly, the internal electrode is uniformly exposed, and the contact area of the external electrode and the internal area is increased. As described above, in an embodiment of the present disclosure, ESR is reduced by increasing the contact area of the external electrode and the internal electrode.

The ceramic capacitor of the aforementioned embodiment may be used as an MLCC which is applied to various items, such as smartphones, PC, TV, and electric vehicles.

### Second Embodiment

A ceramic capacitor according to a second embodiment of the present disclosure is characterized in that an internal electrode is additionally exposed by hole-punching corner parts of a ceramic body so that a maximum contact area can be implemented upon contact of an external electrode and the internal electrode and a side cover part for insulating has been bonded to front and rear surfaces of the ceramic body so that the side of the internal electrode is not exposed to the outside. The ceramic capacitor is a multi-layer ceramic capacitor (MLCC), for example.

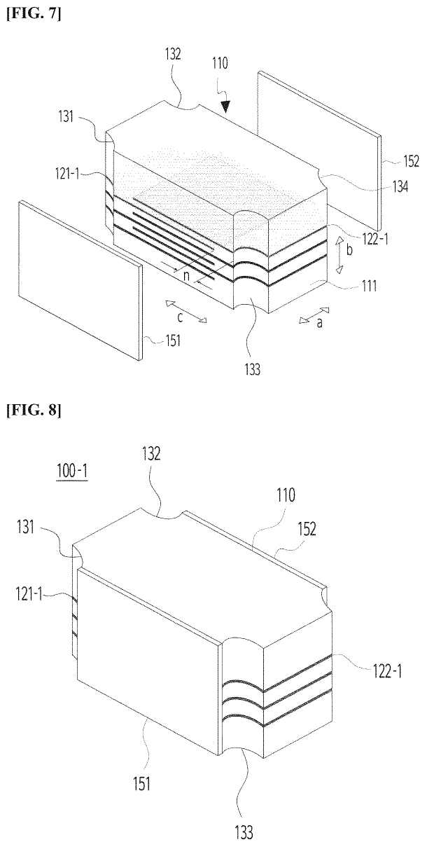

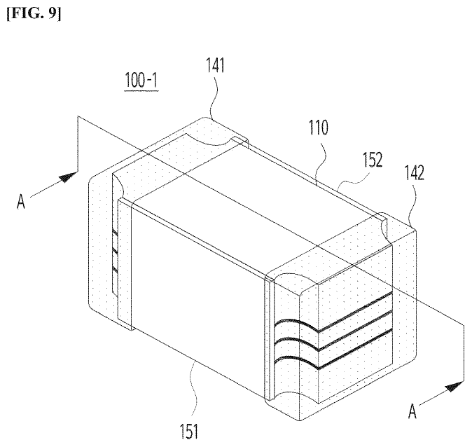

FIG. 7 is a partial perspective view illustrating a form before a side cover part is bonded to a ceramic body of the ceramic capacitor according to the second embodiment of the present disclosure. FIG. 8 is a perspective view illustrating the state in which the side cover part has been bonded to the ceramic body of the ceramic capacitor according to the second embodiment of the present disclosure. In the drawings, a relative thickness or length, or a relative size may be exaggerated for convenience of description and clarity.

As illustrated in FIG. 7, a ceramic capacitor 100-1 according to the second embodiment of the present disclosure includes a ceramic body 110, first and second internal electrodes 121-1 and 122-1, and corner cutting planes 131, 132, 133, and 134.

The ceramic body 110 includes a plurality of dielectric layers. The ceramic body 110 is formed by horizontally stacking a plurality of dielectric layers 111 and then plasticizing the plurality of dielectric layers. The plurality of dielectric layers 111 is in the state in which the plurality of dielectric layers has been sintered. A boundary between adjacent dielectric layers 111 may be integrated to the extent that it is difficult to check the boundary.

A material of the dielectric layer 111 may be barium titanate (BaTiO₃)-based ceramics having a high dielectric constant. In addition, (Ca, Zr)(Sr, Ti)O₃-based ceramics may be used as the material that forms the dielectric layer 111, and the material may additionally include the (Ca, Zr)(Sr, Ti)O₃-based ceramics. However, it is preferred that the dielectric material BaTiO₃ having a high dielectric constant is used because capacitance is proportional to the dielectric constant of a dielectric.

The ceramic body 110 is formed in an approximately rectangular parallelepiped shape, and includes front and rear surfaces that face each other, upper and lower surfaces that face each other, and both end surfaces that face each other. The lower surface of the ceramic body 110 is a mounting surface that is mounted on a board. A surface that faces the lower surface is the upper surface. Two surfaces that are orthogonal to the upper and lower surfaces and that have a long length are the front and rear surfaces. Two surfaces that are orthogonal to the upper and lower surfaces and that have a short length are both end surfaces. That is, in the ceramic body 110, two surfaces that face each other in a direction a are the front and rear surfaces, two surfaces that face each other in a direction b are the upper and lower surfaces, and two surfaces that face each other in a direction c are both end surfaces.

The first internal electrode 121-1 and the second internal electrode 122-1 are disposed to have at least one layer within the ceramic body 110. For example, the first internal electrode 121-1 and the second internal electrode 122-1 may be disposed to have three layers or more within the ceramic body 110, and may be disposed to have several tens or several hundreds of layers in order to increase capacitance.

The first internal electrode 121-1 has one side exposed to one end surface, among both end surfaces of the ceramic body 110, and has the other side that is opposite to the one side disposed within the ceramic body 110. Furthermore, both sides of the first internal electrode 121-1 are exposed to the front and rear surfaces of the ceramic body 110, respectively, so that both sides of the first internal electrode come into contact with one end surface of the ceramic body 110. The second internal electrode 122-1 has one side exposed to the other end surface that is opposite to one end surface, among both end surfaces of the ceramic body 110, and has the other side that is opposite to the one side disposed within the ceramic body 110. Furthermore, the second internal electrode 122-1 is exposed to the front and rear surfaces of the ceramic body 110 so that the second internal electrode comes into contact with the other end surface of the ceramic body 110, and includes a part that overlaps the first internal electrode 121-1. Capacitance is formed at the part at which the first internal electrode 121-1 and the second internal electrode 122-1 overlap.

The first internal electrode 121-1 and the second internal electrode 122-1 may each be formed in various shapes. In an embodiment, the first internal electrode 121-1 and the second internal electrode 122-1 may each have a square shape in which the length of the internal electrode is greater than the width of the internal electrode, for example. In the first internal electrode 121-1 and the second internal electrode 122-1, a part that is exposed to both end surfaces of the ceramic body 110 is denoted as one side, a surface that is opposite to the one side is denoted as the other side, surfaces that face the front and rear surfaces of the ceramic body 110 are denoted as sides.

The corner cutting planes 131, 132, 133, and 134 are formed by cutting four corners of the ceramic body 110 in up and down directions. The cut corner surface of the first internal electrode 121-1 or the second internal electrode 122-1 is exposed to the corner cutting plane 131, 132, 133, 134. The first internal electrode 121-1 is exposed to the two corner cutting planes 131 and 132 that neighbor and come into contact with one end surface of the ceramic body 110. The second internal electrode 122-1 is exposed to the two corner cutting planes 133 and 134 that neighbor and come into contact with the other end surface that is opposite to the one end surface of the ceramic body 110.

In an embodiment, the corner cutting planes 131, 132, 133, and 134 are divided into first corner cutting planes 131 and 132 and second corner cutting planes 133 and 134. The first corner cutting planes 131 and 132 are formed so that one end surface, among both end surfaces of the ceramic body 110, and the front and rear surfaces of the ceramic body 110 meet each other. The second corner cutting planes 133 and 134 are formed so that the other end surface that is opposite to the one end surface, among both end surfaces of the ceramic body 110, and the front and rear surfaces of the ceramic body meet each other. Furthermore, the first internal electrode 121-1 consists of at least one first internal electrode that is disposed within the ceramic body 110 and that is exposed to be connected to one end surface of the ceramic body 110, the first corner cutting planes 131 and 132, and the front and rear surfaces of the ceramic body 110. The second internal electrode 122-1 consists of at least one second internal electrode that is disposed within the ceramic body 110, that is exposed to be connected to the other end surface of the ceramic body 110, the second corner cutting planes 133 and 134, and the front and rear surfaces of the ceramic body 110, and that includes a part that overlaps the first internal electrode 121-1.

The corner cutting planes 131, 132, 133, and 134 may each be formed to have a curved surface. For example, the corner cutting planes 131, 132, 133, and 134 may each have a shape in which the corner cutting plane is depressed from the outside thereof to the inside. The corner cutting planes 131, 132, 133, and 134 additionally expose the first internal electrode 121-1 and the second internal electrode 122-1. The first internal electrode 121-1 and the second internal electrode 122-1 that are exposed through the corner cutting planes 131, 132, 133, and 134 widen a contact area with an external electrode by increasing the exposure area and exposure length of the first internal electrode 121-1 and the second internal electrode 122-1.

In addition, the corner cutting planes 131, 132, 133, and 134 may each have a straight-line incline shape in which the corner of each of the first internal electrode 121-1 and the second internal electrode 122-1 has been cut. However, it is preferred that each of the corner cutting planes 131, 132, 133, and 134 is formed to have a curved surface in order to widen the contact area of the external electrode 141, 142 and the internal electrode 121, 122 and increase contact reliability.

Side cover parts 151 and 152 are bonded to the front and rear surfaces of the ceramic body 110. The side cover parts 151 and 152 cover the first internal electrode 121-1 and the second internal electrode 122-1 that are exposed to the front and rear surfaces of the ceramic body 110 so that the first internal electrode and the second internal electrode are not exposed to the outside. That is, the side cover parts 151 and 152 insulate the first internal electrode 121-1 and the second internal electrode 122-1 exposed to the front and rear surfaces of the ceramic body 110 from an external electrode. The side cover parts 151 and 152 may be made of the same dielectric material as dielectric that has excellent insulation and facilitates manufacturing and that constitutes the ceramic body 110.

As illustrated in FIG. 8, in an embodiment, the first internal electrode 121-1 has both sides covered with the side cover part 151 and is not exposed to the outside, and is exposed through one end surface, among both end surfaces of the ceramic body 110. Furthermore, the first internal electrode is exposed through the first corner cutting planes 131 and 132 that neighbor the one end surface of the ceramic body 110, so that the exposed part forms a “⊏” shape. The second internal electrode 122-1 has both sides covered with the side cover parts 151 and 152 and is not exposed to the outside, and is exposed through the other end surface, among both end surfaces of the ceramic body 110. Furthermore, the second internal electrode is exposed through the second corner cutting planes 133 and 134 that neighbor the other end surface of the ceramic body 110, so that the exposed part forms a “⊏” shape.

The exposure structure of each of the first internal electrode 121-1 and the second internal electrode 122-1 each having the “⊏” shape increases connection strength of the external electrode 141, 142 and the internal electrode 121, 122 and reduces contact resistance by securing a maximum contact area upon contact of the external electrode 141, 142 and the internal electrode 121, 122. A reduction of the contact resistance increases the safety of the entire circuit and improves the lifespan thereof by reducing equivalent series resistance (ESR).

Referring to FIG. 7, the other side of the first internal electrode 121-1 and the other side of the second internal electrode 122-1 are spaced apart from the second corner cutting planes 133 and 134 and the first corner cutting planes 131 and 132 at locations at which they face each other, respectively, at certain distance n. If the other side of the first internal electrode 121-1 is extended up to the second corner cutting planes 133 and 134 that face the other side of the first internal electrode and disposed or the other side of the second internal electrode 122-1 is extended up to the first corner cutting planes 131 and 132 that face the other side of the second internal electrode and disposed, a short occurs if external electrodes 141 are 142 are formed because both the first internal electrode 121-1 and the second internal electrode 122-1 are exposed to the first to fourth corner cutting planes 131, 132, 133, and 134.

It is preferred that the width of each of the first to fourth corner cutting planes 131, 132, 133, and 134 is smaller than the width of both end surfaces of the ceramic body 110. The reason for this is that when the width of each of the first to fourth corner cutting planes 131, 132, 133, and 134 is equal to or relatively greater than the width of both end surfaces of the ceramic body 110, it is difficult to manufacture the ceramic body 110 approximately in a rectangular parallelepiped shape and it is difficult to manufacture a ceramic capacitor having desired characteristics because the area of both end surfaces of the ceramic body 110 is excessively reduced.

The first and second internal electrodes 121-1 and 122-1 may be made of one of Cu, Ni, and Pd-Ag or an alloy of them. In order to suppress the oxidation of the internal electrode during a plasticizing process that is performed at a high temperature, Pd, that is, expensive precious metal, may be used as the internal electrode. For a cost reduction according to requirements for miniaturization and higher capacity of an MLCC, Pd-Ag, Ni, Cu, etc. may be used as the internal electrode.

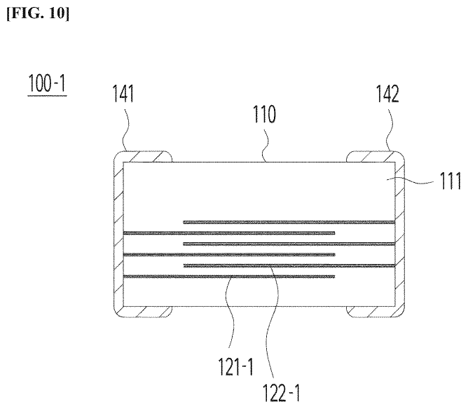

FIG. 9 is a perspective view illustrating the ceramic capacitor according to the second embodiment of the present disclosure.

As illustrated in FIG. 9, the ceramic capacitor 100-1 includes the first and second external electrodes 141 and 142. The first and second external electrodes 141 and 142 are disposed in both end surfaces of the ceramic body 110, respectively, and connected to the first internal electrode 121-1 and the second internal electrode 122-1, respectively.

Referring to FIGS. 8 and 9, the first external electrode 141 is formed to cover one end surface of the ceramic body 110 and the first corner cutting planes 131 and 132. The second external electrode 142 is formed to cover the other end surface of the ceramic body 110 and the second corner cutting planes 133 and 134.

Alternatively, the first external electrode 141 is formed to cover one end surface of the ceramic body 110 and the first corner cutting planes 131 and 132 and up to parts of the side cover parts 151 and 152. The second external electrode 142 is formed to cover the other end surface of the ceramic body 110 and the second corner cutting planes 133 and 134 and up to parts of the side cover parts 151 and 152.

In an embodiment, the first and second external electrodes 141 and 142 are formed to cover both end surfaces of the ceramic body 110, the corner cutting planes 131, 132, 133, and 134, and parts of the side cover parts 151 and 152. Since the first and second external electrodes 141 and 142 are formed to cover the corner cutting planes 131, 132, 133, and 134 and parts of the side cover parts 151 and 152, the first and second external electrodes also come into contact with the first internal electrode 121-1 and the second internal electrode 122-1 exposed through the corner cutting planes 131, 132, 133, and 134. Accordingly, a contact area can be maximized, and moisture can be prevented from being introduced into the first internal electrode 121-1 and the second internal electrode 122-1 through the corner cutting planes 131, 132, 133, and 134.

The first and second external electrodes 141 and 142 may be formed by plating an external electrode material so that the first and second external electrodes cover both end surfaces of the ceramic body 110, the corner cutting planes 131, 132, 133, and 134, and parts of the side cover parts 151 and 152. The first and second external electrodes 141 and 142 may be formed in a form in which the first and second external electrodes fully cover the corner cutting planes 131, 132, 133, and 134 and cover parts of the side cover parts 151 and 152.

Ag or Cu having high electrical conductivity may be used as the external electrode material. Plating layers may be further formed in each of the first and second external electrodes 141 and 142 by plating Ni and Sn. If the Ni and Sn plating layers are further formed in each of the first and second external electrodes 141 and 142, an adhesive force for a board can be increased, and moisture resistance can be improved. For example, the first and second external electrodes 141 and 142 may each be formed to have a three-layer structure including a Cu layer, an Ni layer formed to cover the Cu layer, and an Sn layer formed to cover the Ni layer. Alternatively, the first and second external electrodes 141 and 142 may each be formed to have a four-layer structure having a shock buffer function, further including an Ag epoxy layer between the Cu layer and the Ni layer.

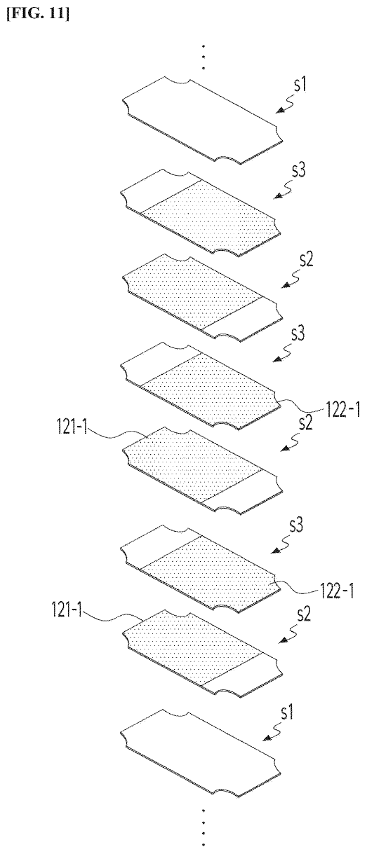

FIG. 10 is a longitudinal cross-sectional view illustrating the ceramic capacitor according to the second embodiment of the present disclosure (a diagram illustrating a cross section A-A in FIG. 9).

As illustrated in FIG. 10, the first and second internal electrodes 121-1 and 122-1 are formed within the ceramic body 110. The first internal electrode 121-1 is exposed to one end surface, among both end surfaces of the ceramic body 110. The second internal electrode 122-1 is exposed to the other end surface, among both end surfaces of the ceramic body 110, and includes a part that overlaps the first internal electrode 121-1.

The first and second internal electrodes 121-1 and 122-1 are electrically connected to the first and second external electrodes 141 and 142, respectively, which are disposed to surround both end surfaces of the ceramic body 110, respectively. In the ceramic capacitor 100-1, when a voltage is applied to the first and second external electrodes 141 and 142, electric charges are accumulated between the first internal electrode 121-1 and the second internal electrode 122-1. In this case, capacitance is proportional to the area of a region in which the first internal electrode 121-1 and the second internal electrode 122-1 overlap. The first and second internal electrodes 121-1 and 122-1 may each be formed in a plural number. The first and second internal electrodes 121-1 and 122-1 may each be formed by printing the internal electrode material on the dielectric layer.

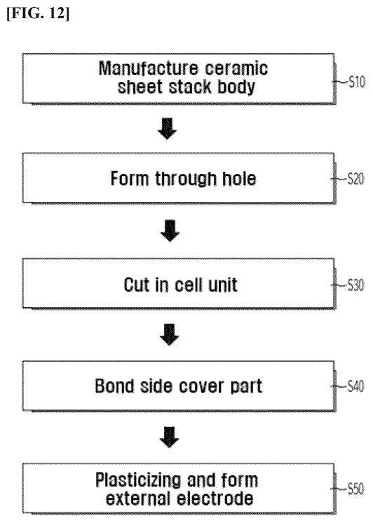

FIG. 11 is an exploded perspective view illustrating the ceramic capacitor according to the second embodiment of the present disclosure.

As illustrated in FIG. 11, the ceramic capacitor 100 may have a form in which a second dielectric layer s2 in which the first internal electrode 121-1 is disposed and a third dielectric layer s3 in which the second internal electrode 122-1 is disposed are alternately stacked on a first dielectric layer s1 that is made of only dielectric and that has at least one layer, at least once, and a first dielectric layer s1 made of only dielectric is stacked on them at least once.

The first internal electrode 121-1 and the second internal electrode 122-1 each have a certain area so that they overlap, and each have a structure in which both sides of each of the first internal electrode 121-1 and the second internal electrode 122-1 are exposed to front and rear surfaces of each of the second dielectric layer s2 and the third dielectric layer s3.

The side cover parts 151 and 152 are bonded to parts at which both sides of the first internal electrode 121-1 and the second internal electrode 122-1 are exposed to the front and rear surfaces of the second dielectric layer s2 and the third dielectric layer s3, respectively, so that the first internal electrode 121-1 and the second internal electrode 122-1 exposed to the front and rear surfaces are insulated from the external electrodes 141 and 142.

The first internal electrode 121-1 and the second internal electrode 122-1 may each be exposed through its end and connected to the external electrode. That is, a part of the first internal electrode 121-1, which is exposed to one end surface of the second dielectric layer s2 and three faces of the first corner cutting planes 131 and 132 that neighbor the one end surface, may be connected to the first external electrode 141. Furthermore, a part of the second internal electrode 122-1, which is exposed to the other end surface of the third dielectric layer s3 and three faces of the second corner cutting planes 133 and 134 that neighbor the other end surface, may be connected to the second external electrode 142.

The first internal electrode 121-1 and the second internal electrode 122-1 may each be formed by printing the internal electrode material on an upper surface of each of the second dielectric layer s2 and the third dielectric layer s3.

The first and second external electrodes 141 and 142 may be formed by printing or applying the external electrode material to both end surfaces of the ceramic body 110 that is manufactured by stacking each of the dielectric layers and compressing, cutting, and plasticizing the dielectric layers.

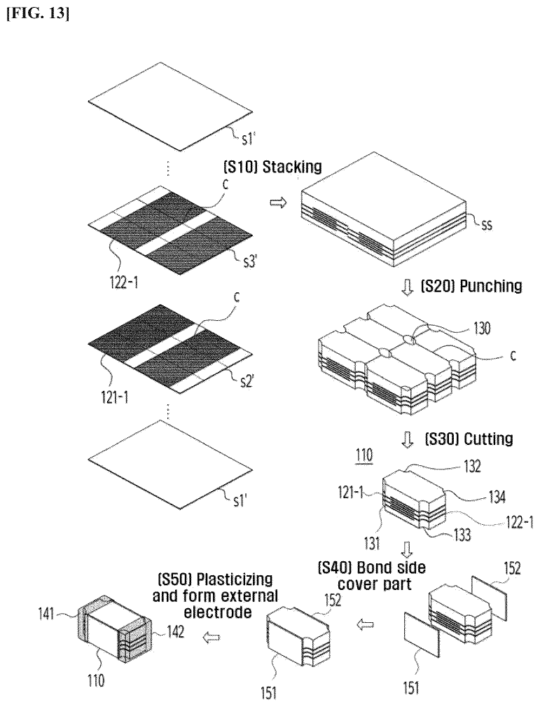

FIG. 12 is a flowchart illustrating a method of manufacturing the ceramic capacitor according to the second embodiment of the present disclosure. FIG. 13 is a construction diagram illustrating the method of manufacturing the ceramic capacitor according to the second embodiment of the present disclosure.

As illustrated in FIGS. 12 and 13, the method of manufacturing the ceramic capacitor includes a step S10 of manufacturing a ceramic sheet stack body ss by stacking the plurality of dielectric layers 111 each including the second dielectric layer s2 on which the first internal electrode 121 has been printed and the third dielectric layer s3 on which the second internal electrode 122 has been printed, a step S20 of forming a through hole 130 at each set location of the ceramic sheet stack body ss, a step S30 of manufacturing a plurality of ceramic bodies 110 in each of the corner cutting planes 131, 132, 133, and 134 have been formed by cutting the ceramic sheet stack body ss in a plurality of cell units so that the through hole 130 is quartered on the basis of the center of the through hole 130, and a step S40 of bonding the side cover parts 151 and 152 to the front and rear surfaces of the ceramic body 110.

The method further includes a step S50 of forming the first external electrode 141 that covers one end surface of the ceramic body 110 and the first corner cutting planes 131 and 132 in the one end surface of the ceramic body 110 and forming the second external electrode 142 that covers the other end surface of the ceramic body 110 and the second corner cutting planes 133 and 134 in the other end surface of the ceramic body 110, after the step S40 of bonding the side cover parts 151 and 152 to the front and rear surfaces of the ceramic body 110.

The first external electrode 141 may have a form in which the first external electrode covers one end surface of the ceramic body 110 and the first corner cutting planes 131 and 132 and up to parts of the side cover parts 151 and 152. The second external electrode 142 may have a form in which the second external electrode covers the other end surface of the ceramic body 110 and the second corner cutting planes 133 and 134 and up to parts of the side cover parts 151 and 152.

As illustrated in FIG. 13, in the step S10 of manufacturing the ceramic sheet stack body, the first internal electrode 121-1 is disposed by being printed on a second dielectric layer s2′ in a plural number. The second internal electrode 122-1 is printed and disposed in a third dielectric layer s3′ in a plural number so that the second internal electrode includes a part that overlaps the first internal electrode 121-1.

A first dielectric layer s1′ is a ceramic sheet that is manufactured by using only a dielectric material. The second dielectric layer s2′ is formed by printing the plurality of first internal electrodes 121-1 on an upper surface of the ceramic sheet manufactured by using a dielectric material. The third dielectric layer s3′ is formed by printing the plurality of second internal electrodes 122-1 on the upper surface of the ceramic sheet manufactured by using a dielectric material.

The first internal electrode 121-1 has one side come into contact with one end surface of the second dielectric layer s2′ or come into contact with a cutting line (c) part that will become the one end surface, has the other side spaced apart from a cutting line (c) part that will become the other end surface of the second dielectric layer s2′ or the other end surface of the second dielectric layer s2′ at a certain distance, and has both sides printed on the upper surface of the second dielectric layer s2′ in a plural number so that the both sides are exposed to front and rear surfaces of the second dielectric layer s1′.

The material of the dielectric layer 111 may be barium titanate (BaTiO₃)-based ceramics having a high dielectric constant.

A material of each of the first and second internal electrodes 121-1 and 122-1 may be made of one of Cu, Ni, and Pd-Ag or an alloy of them.

The second internal electrode 122-1 has one side come into contact with the other end surface of the third dielectric layer s3′ or come into contact with a cutting line (c) part that will become the other end surface, has the other side spaced apart from a cutting line (c) part that will become one end surface of the third dielectric layer s3′ or the one end surface of the third dielectric layer s3′ at a certain distance, and has both sides printed on an upper surface of the third dielectric layer s3′ in a plural number so that the both sides are exposed to front and rear surfaces of the third dielectric layer s3′.

The first internal electrode 121-1 and the second internal electrode 122-1 can be easily aligned because all of the first internal electrode and the second internal electrode are printed without an interval between both sides of the internal electrode when the internal electrode is printed on each of the dielectric layers s2′ and s3′.

In the step S20 of forming the through hole at each set location of the ceramic sheet stack body, the through hole 130 may be formed by using a punching machine having a cylinder shape or a laser. In an embodiment, for example, the plurality of through holes 130 may be formed in the ceramic sheet stack body ss at certain intervals by using the punching machine having a cylinder shape.

The step S20 of forming the through hole at each set location of the ceramic sheet stack body and the step S30 of manufacturing the plurality of ceramic sheet stack body cell units in each of which the corner cutting planes 131, 132, 133, and 134 have been formed by cutting the ceramic sheet stack body ss so that the through hole is quartered on the basis of the center of the through hole may be simultaneously performed by using the punching machine having a cylinder shape and a punching device having a punch blade. If the forming of the through hole and the cutting of the ceramic sheet stack body ss are simultaneously performed by using the punching device, it is advantageous for mass production because a manufacturing time is reduced.

If the plurality of ceramic bodies 110 in each of which the corner cutting planes 131, 132, 133, and 134 have been formed by cutting the ceramic sheet stack body so that the through hole 130 is quartered on the basis of the center of the through hole 130 is manufactured, it is easy to implement a maximum contact area upon a contact with the external electrode 141, 142 because the plurality of ceramic bodies has the same clean cutting surface. If the contact area of the external electrode 141, 142 and the internal electrode 121, 122 is implemented to the maximum, ESR can be reduced.

After the step S30 of manufacturing the plurality of ceramic bodies 110 in each of which the corner cutting planes 131, 132, 133, and 134 have been formed by cutting the stack body so that the through hole is quartered on the basis of the center of the through hole, the step S40 of bonding the side cover parts 151 and 152 to the front and rear surfaces of the ceramic body 110 is performed.

In the step of bonding the side cover parts 151 and 152 to the front and rear surfaces of the ceramic body 110, the side cover parts 151 and 152 each made of dielectric and having a flat panel shape may be bonded to the front and rear surfaces of the ceramic body 110 except the corner cutting planes 131, 132, 133, and 134, or the side cover parts may be formed by printing a dielectric material on the front and rear surfaces of the ceramic body 110 except the corner cutting planes 131, 132, 133, and 134.

After the step of bonding the side cover parts 151 and 152 to the front and rear surfaces of the ceramic body, a step of plasticizing the ceramic body 110 is performed. In the plasticizing step, the side cover parts 151 and 152 are bonded to the ceramic body 110 by sintering, and the state in which the side cover parts 151 and 152 have been bonded to the ceramic body 110 is firmly maintained.

After the step of plasticizing the ceramic body 110, a step S50 of forming the first and second external electrodes 141 and 142 so that the first and second external electrodes cover both end surfaces of the ceramic body 110 and the corner cutting planes 131, 132, 133, and 134 is performed.

Ag or Cu having high electrical conductivity may be used as the external electrode material.

An embodiment exemplifies that after the step of bonding the side cover parts 151 and 152 to the front and rear surfaces of the ceramic body, the ceramic body 110 is plasticized and the first and second external electrodes 141 and 142 are formed to cover both end surfaces of the plasticized ceramic body 110, the corner cutting planes 131, 132, 133, and 134, and parts of the side cover parts 151 and 152.

The aforementioned embodiment has advantages in that it is easy to implement a maximum contact area upon contact of the external electrode and the internal electrode due to the clean cutting surface, the contact area of the external electrode and the internal electrode can be increased because the internal electrode is additionally exposed and comes into contact with the external electrode through the corner cutting plane, and a ceramic capacitor can be mass-produced through a simple manufacturing process because insulation can be secured through the side cover parts 151 and 152 although the first internal electrode 121-1 and the second internal electrode 122-1 are manufactured to be exposed to both sides of the ceramic body 110.

That is, in the embodiment of the present disclosure manufactured by the aforementioned method, the contact area of the external electrode and the internal area is increased by the internal electrode that is exposed through the corner cutting plane and because the plurality of ceramic bodies in each of which the corner cutting plane has been formed is manufactured by cutting the ceramic sheet stack body in a plurality of cell units. Accordingly, contact resistance of the external electrode and the internal electrode is reduced, and equivalent series resistance (ESR) is reduced.

Furthermore, in an embodiment of the present disclosure, the bonding stability of the side cover parts 151 and 152 is increased because the ceramic body is manufactured by cutting the ceramic sheet stack body in a cell unit and has a clean cutting surface. The contact area of the external electrode and the internal area is increased because the internal electrode is also uniformly exposed. As described above, according to an embodiment of the present disclosure, ESR can be reduced by increasing the contact area of the external electrode and the internal electrode to the maximum.

The ceramic capacitor of the aforementioned embodiment may be used as an MLCC which is applied to various items, such as smartphones, PC, TV, and electric vehicles.

The above description is merely a description of the technical spirit of the present disclosure, and those skilled in the art may change and modify the present disclosure in various ways without departing from the essential characteristic of the present disclosure. Accordingly, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. A ceramic capacitor comprising:
a ceramic body comprising a plurality of dielectric layers and comprising front and rear surfaces that face each other, upper and lower surfaces that face each other, and both end surfaces that face each other;
a first corner cutting plane formed to meet one end surface, among the both end surfaces of the ceramic body, and the front and rear surfaces of the ceramic body;
a second corner cutting plane formed to meet the other end surface that is opposite to the one end surface, among the both end surfaces of the ceramic body, and the front and rear surfaces of the ceramic body;
at least one first internal electrode disposed within the ceramic body and exposed to be connected to the one end surface of the ceramic body and the first corner cutting plane; and
at least one second internal electrode disposed within the ceramic body, exposed to be connected to the other end surface of the ceramic body and the second corner cutting plane, and comprising a part that overlaps the first internal electrode.

2. The ceramic capacitor of claim 1, wherein the first corner cutting plane is formed to have a curved surface.

3. The ceramic capacitor of claim 1, wherein the first internal electrode is spaced apart from the front and rear surfaces of the ceramic body at a certain distance and not exposed to an outside.

4. The ceramic capacitor of claim 1, further comprising first and second external electrodes disposed in the both end surfaces of the ceramic body, respectively, and connected to the first internal electrode and the second internal electrode, respectively,
wherein the first external electrode covers the one end surface of the ceramic body and the first corner cutting plane.

5. The ceramic capacitor of claim 1, wherein:
the first internal electrode has one side exposed to the one end surface of the ceramic body and the other side disposed within the ceramic body, and
the other side of the first internal electrode is spaced apart from the second corner cutting plane at a certain distance.

6. The ceramic capacitor of claim 1, wherein the first internal electrode and the second internal electrode are exposed to be connected to the front and rear surfaces of the ceramic body.

7. The ceramic capacitor of claim 6, further comprising a side cover part bonded to the front and rear surfaces of the ceramic body and configured to cover the first internal electrode and the second internal electrode exposed to the front and rear surfaces of the ceramic body.

8. The ceramic capacitor of claim 7, wherein the side cover part is made of dielectric.

9. The ceramic capacitor of claim 4, wherein the first external electrode covers up to a part of the side cover part.

10. The ceramic capacitor of claim 6, wherein:
the first internal electrode is disposed in the dielectric layer, and
the dielectric layer exposes both sides of the first internal electrode to an outside.

11. A method of manufacturing a ceramic capacitor, comprising steps of:
manufacturing a ceramic sheet stack body by stacking a plurality of dielectric layers comprising a dielectric layer on which a first internal electrode has been printed and a dielectric layer on which a second internal electrode has been printed;
forming a through hole at each set location of the ceramic sheet stack body; and
manufacturing a plurality of ceramic bodies in each of which first corner cutting planes are formed on both sides of one end surface thereof and second corner cutting planes are formed on both sides of the other end surface thereof by cutting the ceramic sheet stack body in a plurality of cell units so that the through hole is quartered on the basis of a center of the through hole.

12. The method of claim 11, wherein in the step of manufacturing the ceramic sheet stack body by stacking the plurality of dielectric layers comprising the dielectric layer on which the first internal electrode has been printed and the dielectric layer on which the second internal electrode has been printed,
wherein the first internal electrode is printed on an upper surface of the dielectric layer in a plural number so that the first internal electrode has one side come into contact with one end surface of the dielectric layer or come into contact with a cutting line part that is to become the one end surface of the dielectric layer, has the other side spaced apart from a cutting line part that is to become the other end surface of the dielectric layer or the other end surface of the dielectric layer at a certain distance, and has both sides spaced apart from front and rear surfaces of the dielectric layer or a cutting line part that is to become the front and rear surfaces of the dielectric layer at a certain distance.

13. The method of claim 11, wherein in the step of manufacturing the ceramic sheet stack body by stacking the plurality of dielectric layers comprising the dielectric layer on which the first internal electrode has been printed and the dielectric layer on which the second internal electrode has been printed,
wherein the second internal electrode is printed on an upper surface of the dielectric layer in a plural number so that the second internal electrode has one side come into contact with the other end surface of the dielectric layer or come into contact with a cutting line part that is to become the other end surface of the dielectric layer, has the other side spaced apart from a cutting line part that is to become the one end surface of the dielectric layer or the one end surface of the dielectric layer at a certain distance, and has both sides spaced apart from front and rear surfaces of the dielectric layer or a cutting line part that is to become the front and rear surfaces of the dielectric at a certain distance.

14. The method of claim 11, wherein the step of forming the through hole at each set location of the ceramic sheet stack body and the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole are simultaneously performed by using a punching machine having a cylinder shape and a punching device having a punch blade.

15. The method of claim 11, wherein:
a step of plasticizing the ceramic body is performed after the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole,
a step of forming first and second external electrodes that connect the first and second internal electrodes to the both end surfaces of the ceramic body, respectively, is performed after the step of plasticizing the ceramic body, and
the first external electrode is formed to cover the one end surface of the ceramic body and the first corner cutting plane.

16. The method of claim 11, further comprising a step of bonding a side cover part to front and rear surfaces of the ceramic body, after the step of manufacturing the plurality of ceramic bodies in each of which the first corner cutting planes are formed on the both sides of the one end surface thereof and second corner cutting planes are formed on the both sides of the other end surface thereof by cutting the ceramic sheet stack body in the plurality of cell units so that the through hole is quartered on the basis of the center of the through hole.

17. The method of claim 16, wherein in the step of manufacturing the ceramic sheet stack body by stacking the plurality of dielectric layers comprising the dielectric layer on which the first internal electrode has been printed and the dielectric layer on which the second internal electrode has been printed,
wherein the first internal electrode is printed on an upper surface of the dielectric layer in a plural number so that the first internal electrode has one side come into contact with one end surface of the dielectric layer or come into contact with a cutting line part that is to become the one end surface of the dielectric layer, has the other side spaced apart from a cutting line part that is to become the other end surface of the dielectric layer or the other end surface of the dielectric layer at a certain distance, and has both sides exposed to front and rear surfaces of the dielectric layer.

18. The method of claim 16, wherein in the step of manufacturing the ceramic sheet stack body by stacking the plurality of dielectric layers comprising the dielectric layer on which the first internal electrode has been printed and the dielectric layer on which the second internal electrode has been printed,
wherein the second internal electrode is printed on an upper surface of the dielectric layer in a plural number so that the second internal electrode has one side come into contact with the other end surface of the dielectric layer or come into contact with a cutting line part that is to become the other end surface of the dielectric layer, has the other side spaced apart from a cutting line part that is to become the one end surface of the dielectric layer or the one end surface of the dielectric layer at a certain distance, and has both sides exposed to front and rear surfaces of the dielectric layer.

19. The method of claim 16, wherein in the step of bonding the side cover part to the front and rear surfaces of the ceramic body,
the side cover part made of dielectric and configured to have a flat panel shape is bonded to the front and rear surfaces of the ceramic body except the corner cutting plane, or
the side cover part is formed by printing a dielectric material on the front and rear surfaces of the ceramic body except the corner cutting plane.

20. The method of claim 16, wherein:
the step of plasticizing the ceramic body is performed after the step of bonding the side cover part to the front and rear surfaces of the ceramic body,
a step of forming first and second external electrodes connected to the first and second internal electrodes, respectively, in the both end surfaces of the ceramic body is performed after the step of plasticizing the ceramic body, and
the first external electrode is formed to cover the one end surface of the ceramic body, the first corner cutting plane, and up to a part of the side cover part.
